(19) United States
(12) Patent Application Publication
(10) Pub. No.: US 2010/0122544 A1
(43) Pub. Date: May 20, 2010

(54) MICRO-CHANNEL HEAT EXCHANGER FOR CARBON DIOXIDE REFRIGERANT, FLUID DISTRIBUTER THEREOF AND METHOD OF FABRICATING HEAT EXCHANGER

(75) Inventors: Chun-Chung YANG, Hsinchu City (TW); Yu-Choung CHANG, Hsinchu County (TW); Pei-Yu YU, Pingtung County (TW); Bo-Chin WANG, Yunlin County (TW)

Correspondence Address: APEX JURIS, PLLC, 12733 LAKE CITY WAY NORTHEAST, SEATTLE, WA, 98125, US

(73) Assignee: INDUSTRIAL TECHNOLOGY RESEARCH INSTITUTE, Hsinchu (TW)

(21) Appl. No.: 12/426,802

(22) Filed: Apr. 20, 2009

(30) Foreign Application Priority Data
Nov. 17, 2008 (TW) 097144429

(51) Int. Cl. F25D 23/00; F25B 1/00; F28F 9/04; B23P 15/26

(52) U.S. Cl. 62/259.1; 62/498; 165/178; 29/890.053; 29/890.054

(57) ABSTRACT

A micro-channel heat exchanger module is respectively connected to a compressor and an expansion device. The micro-channel heat exchanger module includes a heat transfer tube module and a block. The block has a working fluid inlet channel, a working fluid outlet channel, a working fluid distribution chamber, a plurality of working fluid outlet openings, and a plurality of working fluid inlet openings. The working fluid inlet channel is connected to one of a compressor and an expansion device. The working fluid distribution chamber communicates with the working fluid inlet channel. The working fluid outlet openings communicate the working fluid distribution chamber with the heat transfer tube module. The working fluid inlet openings communicate the heat sink with the working fluid outlet channel. The working fluid outlet channel is connected to the other one of the compressor and the expansion device.

### CROSS-REFERENCE TO RELATED APPLICATIONS

This non-provisional application claims priority under 35 U.S.C. § 119(a) on Patent Application No(s). 097144429 filed in Taiwan, R.O.C. on Nov. 17, 2008 the entire contents of which are hereby incorporated by reference.

### BACKGROUND OF THE INVENTION

1. Field of Invention

The present invention relates to an apparatus of a micro-channel heat exchanger module and a method of fabricating the same, and more particularly to a micro-channel heat exchanger module capable of condensing a high pressure gaseous working fluid to the liquid working fluid, a working fluid distributor thereof, and a method of fabricating the micro-channel heat exchanger module.

2. Related Art

Recently, people internationally pay attention to global ecologic protection and energy saving and carbon reduction topics. Based on the attention on the environmental protection topics, including Montreal Protocol and Kyoto Protocol, countries in the world have practiced in controlling compound refrigerant containing halide and greenhouse gas emission, and at the same time shown the international decision of protecting the global ecology and the environment. Therefore, in the refrigerating and air conditioning field, the application of the natural refrigerant becomes an important topic.

Currently, among alternative refrigerant being internationally developed and popularized, a carbon dioxide refrigerant is a natural refrigerant having a development potential. This is because that, the carbon dioxide refrigerant satisfies the environmental protection concept, in addition, the carbon dioxide refrigerant is obtained from nature and is refined, such that as compared with conventional chlorofluorocarbon compound or the alternative refrigerant, the carbon dioxide refrigerant has an advantage of low cost (the price is roughly one tenth of the price of the conventional chlorofluorocarbon compound or the alternative refrigerant or lower). Further, as compared with the conventional refrigerant or other alternative refrigerants, the carbon dioxide refrigerant has the advantages of being environmental friendly, secure, efficient, and having better heat pump characteristics. Moreover, a critical temperature of the carbon dioxide refrigerant quite approaches the normal temperature (approximately 31.1° C.), during a compression process, the carbon dioxide refrigerant quite easily enters a supercritical state, and a density thereof is several times higher than that of the conventional refrigerant, such that when the carbon dioxide is used as the working refrigerant, for the design disposition of the system and the tube module, the equivalent heat transfer capacity may be reached with smaller volume or specification capacity. In addition, a working pressure of the carbon dioxide refrigerant is extremely high, such that a micro-channel heat transfer tube module structure must be adopted, so as to obtain the preferred structural strength and the heat transfer capability. Based on the above reasons, it becomes one of the important researching directions in the refrigerating and air conditioning field for the academic circles or the industrial circles how to further understand the heat conductive characteristics of the carbon dioxide refrigerant in the supercritical state and the related techniques of the commercial application of the carbon dioxide refrigerant.

FIG. 1 is a schematic view of a conventional refrigerating cycle; whose condenser adopting the working refrigerant. Referring to FIG. 1, a condenser 500 includes a refrigerant inlet tube 510, a plurality of heat transfer tube module 520, and a refrigerant outlet tube (not shown). The heat transfer tube module 520 communicates the refrigerant inlet tube 510 with the refrigerant outlet tube. Therefore, the gaseous working refrigerant enters the heat transfer tube module 520 through the refrigerant inlet tube 510, and is condensed to the liquid working refrigerant in the heat transfer tube module 520. The condensed working refrigerant flows to the element of a next refrigerating cycle through the refrigerant outlet tube (not shown).

Generally, for a conventional method of fabricating the condenser 500, a part of a tube wall of the refrigerant inlet tube 510 is squeezed inward by punching, and a part of the tube wall is damaged, so as to form a plurality of openings 512. Then, the heat transfer tube modules 520 are inserted with the refrigerant inlet tube 510 through the openings 512, and the heat transfer tube modules 520 are fixed with the refrigerant inlet tube 510 by brazing.

However, the condenser 500 has the problems as follows on operation.

In a refrigerating cycle which use the carbon dioxide as the working refrigerant, the working pressure of the working refrigerant is quite high (about 90-120 kg/cm²), and the designer must consider the volume of the condenser on design, such that; usually the heat transfer tube module 520 of the condenser 500 adopt thin tubes having a tube diameter of small than below 1.0 mm. In this manner, when the heat transfer tube module 520 and the refrigerant inlet tube 510 are brazed, the solder 530 in a melted state is infiltrated to an end surface 522 of the heat transfer tube module 520 along a slit between the heat transfer tube module 520 and the refrigerant inlet tube 510 by reason of a capillary action. The tube diameter of the heat transfer tube module 520 is quite small, such that the solder 530 in the melted state infiltrated to the end surface 522 is absorbed in the heat transfer tube module 520 by reason of the capillary action, such that the channel of the heat transfer tube module 520 is obstructed.

In addition, based on the above structure, the heat transfer tube modules 520 are inserted with the refrigerant inlet tube 510, such that end portions of the heat transfer tube modules 520 are raised inward from the tube wall of the refrigerant inlet tube 510, in this manner, usually it becomes the barrier or the obstruction to the flow of refrigerant.

In addition, in the prior art, a front end inlet and a back end outlet of the refrigerant inlet tube 510 are usually connected by a penetrating channel. In the structure, for the refrigerant flowing from the main channel to each heat transfer tube module 520, by reason of the pressure drop of the tube line, the flows of the refrigerant flowing to the heat transfer tube module 520 located on the front end and the back end of the refrigerant inlet tube 510 are not uniform and generate a difference, thereby seriously resulting in abnormal problems of non-uniform heat transfer distribution of the whole heat exchanger and consequently reduced the heat transfer capability.

### SUMMARY OF THE INVENTION

Accordingly, the present invention is directed to a working fluid distributor and a micro-channel heat exchanger module with a modified structure, thereby preventing problems such as a refrigerant flow distribution of working fluid in a channel and soldering obstruction in a channel during the process of fabricating the heat exchanger.

The present invention is further directed to a method of fabricating a micro-channel heat exchanger module, thereby preventing the problem that heat transfer tube are obstructed by solder during a brazing process.

The present invention provides a working fluid distributor, which is respectively connected to a compressor, an expansion device, and a heat transfer tube module. The working fluid distributor includes a block. The block has a working fluid inlet channel, a working fluid outlet channel, a working fluid distribution chamber, a plurality of working fluid outlet openings, and a plurality of working fluid inlet openings. The working fluid inlet channel is connected to one of a compressor and an expansion device. The working fluid distribution chamber communicates with the working fluid inlet channel and the working fluid outlet channel. The working fluid outlet openings communicate the working fluid distribution chamber with the heat sink. The working fluid inlet openings communicate the working fluid outlet channel with the heat sink. The working fluid outlet channel communicates with the other one of the compressor and the expansion device.

The micro-channel heat exchanger module of the present invention is respectively connected to a compressor and an expansion device. The micro-channel heat exchanger module includes a heat transfer tube module and a block. The block has a working fluid inlet channel, a working fluid outlet channel, a working fluid distribution chamber, a plurality of working fluid outlet openings, and a plurality of working fluid inlet openings. The working fluid inlet channel is connected to one of a compressor and an expansion device. The working fluid distribution chamber communicates with the working fluid inlet channel. The working fluid outlet openings communicate the working fluid distribution chamber with the heat sink. The working fluid inlet openings communicate the working fluid outlet channel with the heat sink. The working fluid outlet channel communicates with the other one of the compressor and the expansion device. According to a preferred embodiment of the present invention, the heat transfer tube module includes a plurality of heat transfer tube module. Each heat transfer tube module has a first end and a second end. The first end communicates with a corresponding working fluid outlet opening, and the second end communicates with a corresponding working fluid inlet opening. Preferably, an extending direction of the first end is vertical to an extending direction of the working fluid inlet channel. In addition, an extending direction of the second end is vertical to an extending direction of the working fluid outlet channel.

According to a preferred embodiment of the present invention, the working fluid distributor is a distributor of carbon dioxide refrigerant.

According to a preferred embodiment of the present invention, the micro-channel heat exchanger module is a micro-channel heat exchanger module of carbon dioxide refrigerant.

According to a preferred embodiment of the present invention, the working fluid distribution chamber has a chamber bottom surface. The working fluid outlet opening is located on the chamber bottom surface. The first end of the heat transfer tube module is inserted to the block from the working fluid outlet opening, and the first end is not raised to the working fluid distribution chamber from the chamber bottom surface.

According to a preferred embodiment of the present invention, the working fluid outlet channel has a channel bottom surface. The working fluid outlet is located on the channel bottom surface. The second end is inserted to the block from the working fluid inlet opening, and the second end is not raised to the working fluid outlet channel from the channel bottom surface.

According to a preferred embodiment of the present invention, the block includes a plurality of sub blocks, each sub block has a working fluid inlet channel section, a working fluid outlet channel section, the working fluid distribution chamber, the working fluid outlet openings, and the working fluid inlet openings. The working fluid distribution chamber communicates with the working fluid inlet channel section. The working fluid inlet openings communicate with the working fluid outlet channel section. The working fluid inlet channel section defines a part of the working fluid inlet channel. The working fluid outlet channel section defines a part of the working fluid outlet channel.

According to a preferred embodiment of the present invention, the sub block further includes a male connector and a female connector. The male connector of the sub block is jointed with the female connector of another sub block. Preferably, the male connector communicates with one of the working fluid inlet channel section and the working fluid outlet channel section. In addition, the female connector also communicates with one of the working fluid inlet channel section and the working fluid outlet channel section.

The method of fabricating the micro-channel heat exchanger module of the present invention includes the steps as follows. Firstly, an object to be processed is provided, and the object to be processed has a working fluid inlet channel, a working fluid outlet channel, a working fluid distribution chamber, a plurality of working fluid openings, and a plurality of soldering openings. The working fluid distribution chamber communicates with the working fluid inlet channel. The working fluid distribution chamber has a chamber bottom surface. The working fluid openings are located on the bottom surface, a part of the working fluid openings communicate with the working fluid distribution chamber, and the remaining working fluid openings communicate with the working fluid outlet channel. The soldering openings communicate the working fluid distribution chamber with an external environment, and the soldering openings are located on chamber top surface of the working fluid distribution chamber. Next, a plurality of heat transfer tube module and a plurality of stopping blocks are provided, and a solder resist process is performed on the stopping blocks. Then, an end portion of the heat sink tubes communicates with the working fluid outlet channel, and the other end portion of the heat transfer tube module is inserted to the corresponding working fluid outlet opening, the other end portion is not raised to the working fluid distribution chamber from the chamber bottom surface, and the stopping blocks are inserted to the working fluid distribution chamber through the soldering openings, such that a surface of the stopping blocks leans against an end surface of the end portion of the heat transfer tube module.

Then, a soldering process is performed, so as to fix the heat transfer tube module on the object to be processed. Next, the stopping blocks are removed. Finally, the soldering openings are sealed.

According to a preferred embodiment of the present invention, the soldering step is a brazing procedure.

According to a preferred embodiment of the present invention, the method of fabricating the heat transfer tube module further includes forming a flange with a profile corresponding to the end portion of the heat transfer tube module on the end surface of the stopping block. When the stopping block contacts with the end portion of the heat transfer tube module, the flange surrounds an outer surface of the end portion.

According to a preferred embodiment of the present invention, the step of performing the solder resist process on the stopping blocks includes performing a carbonizing process on the surfaces of the stopping blocks.

The efficacies of the present invention are as follows. The block of the present invention has the design of the working fluid distribution chamber. Before entering the plurality of working fluid outlet openings from the working fluid inlet channel, the working fluid firstly flows through the working fluid distribution chamber and being directed and distributed, such that through the design of the present invention, the flow of the working fluid becomes more uniform and smoother. In addition, the end portion of the heat transfer tube module of the present invention is not raised to the working fluid distribution chamber from the chamber bottom surface. Therefore, as compared with the prior art, when the working fluid enters the heat sink tube from the working fluid outlet channel, the end portion of the heat transfer tube module does not obstruct the flow of the working fluid. Therefore, the design of the heat transfer tube module of the present invention enables the flow of the working fluid much smoother.

Further, in the method of fabricating the heat transfer tube module of the present invention, before the soldering process is performed, an anti-soldered stopping block is placed on the end surface of the heat transfer tube module, such that during the soldering process, the solder in a melted state will not enter the channel of the heat transfer tube module under the effect of a capillary action. Therefore, the present invention may effectively prevent the heat transfer tube module from being obstructed by the solder.

### BRIEF DESCRIPTION OF THE DRAWINGS

The present invention will become more fully understood from the detailed description given herein below for illustration only, and thus are not limitative of the present invention, and wherein:

FIG. 1 is a schematic view of a conventional refrigerating cycle condenser adopting a working refrigerant;

FIG. 2 is a schematic view of a working fluid distributor according to an embodiment of the present invention;

FIG. 3 is a schematic sectional view of FIG. 2;

FIG. 4 is a schematic view of a sub block used to form a block;

FIG. 5 is a schematic sectional view of FIG. 4;

FIG. 6 is a schematic view of a micro-channel heat exchanger module having the block according to an embodiment of the present invention;

FIG. 7 is a schematic partial enlarged view of FIG. 6;

FIG. 8 is a schematic sectional view relative to a first end of a heat transfer tube module of FIG. 6;

FIG. 9 is a schematic sectional view relative to a second end of the heat transfer tube module of FIG. 6;

FIGS. 10A to 10C are schematic flow charts of fabricating the micro-channel heat exchanger module according to an embodiment of the present invention;

FIG. 11A is a schematic longitudinal sectional view of FIG. 10A;

FIG. 11B is a schematic cross-sectional view of FIG. 10A; and

FIG. 12 is a schematic sectional view of FIG. 10C.

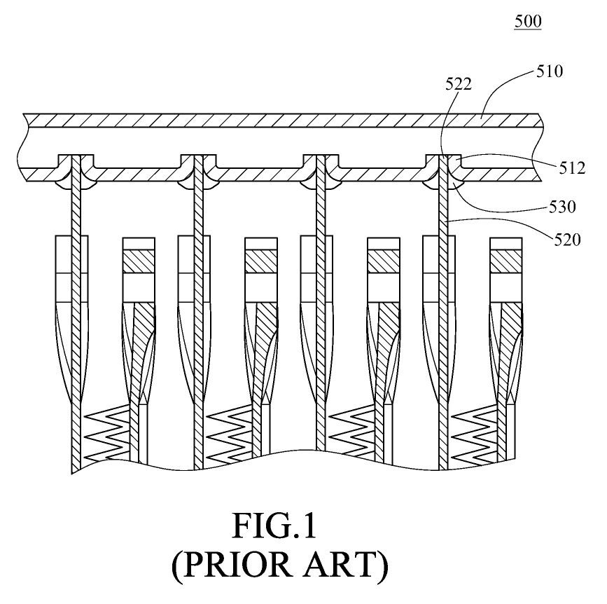

### DETAILED DESCRIPTION OF THE INVENTION

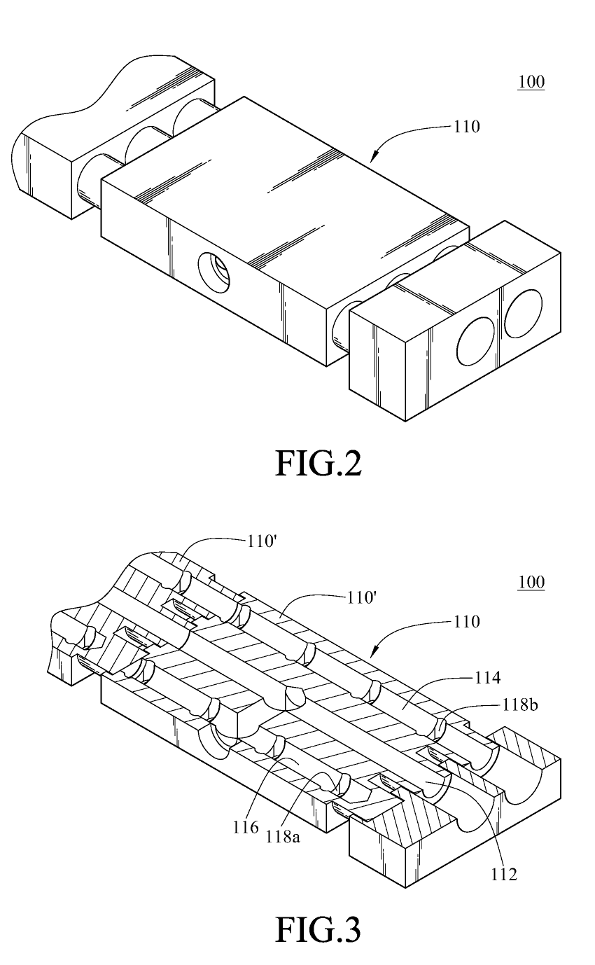

FIG. 2 is a schematic view of a working fluid distributor according to an embodiment of the present invention, and FIG. 3 is a schematic sectional view of FIG. 2. Referring to FIGS. 2 and 3, a working fluid distributor 100 includes a block 110. The block 110 has a working fluid inlet channel 112, a working fluid outlet channel 114, a working fluid distribution chamber 116, and a plurality of working fluid openings, in which the working fluid openings are distributed into a plurality of working fluid outlet openings 118a and a plurality of working fluid inlet openings 118b according to flowing paths of a working fluid. The working fluid inlet channel 112 is used to receive the working fluid from a compressor or an expansion device, and the working fluid may be a carbon dioxide refrigerant or other types of refrigerants. The working fluid distribution chamber 116 communicates with the working fluid inlet channel 112. The working fluid outlet openings 118a communicate the working fluid distribution chamber 116 with a heat transfer tube module (not shown), the working fluid inlet openings 118b communicate the working fluid outlet channel 114 with the heat transfer tube module (not shown), and a connection manner between the heat transfer tube module (not shown) and the block 110 is described in detail below. The working fluid outlet channel 114 is used to outlet the working fluid from the block 110 to the other one of the compressor and the expansion device. In other words, when the working fluid inlet channel 112 is used to receive the working fluid from the compressor, the working fluid outlet channel 114 is used to outlet the working fluid from the block 110 to the expansion device. When the working fluid inlet channel 112 is used to receive the working fluid from the expansion device, the working fluid outlet channel 114 is used to outlet the working fluid from the block 110 to the compressor.

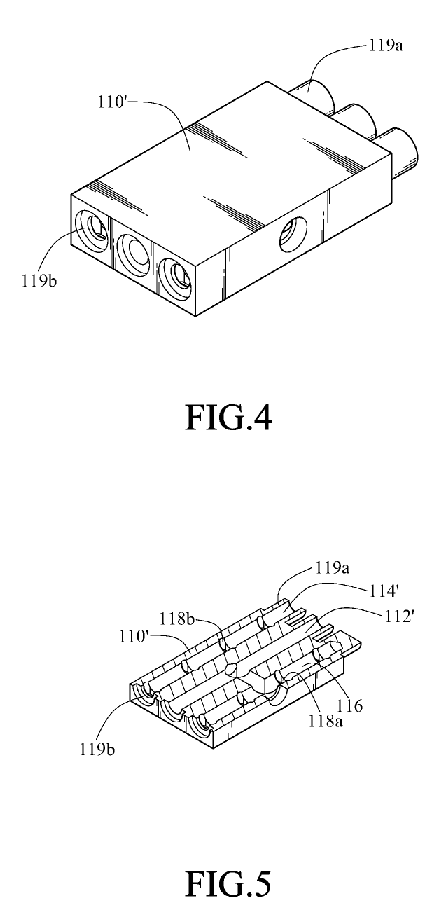

Generally, a size of the working fluid distributor is determined according to a flow of the working fluid, a heat conduction amount of the heat exchanger, or other design conditions. For ease of fabrication, the block 110 of this embodiment may be composed of a plurality of sub blocks 110′ (FIG. 4).

Referring to FIGS. 4 and 5, FIG. 4 is a schematic view of the sub block 110′ used to form the block 110, and FIG. 5 is a schematic sectional view of FIG. 4. The sub block 110′ has a working fluid inlet channel section 112′, a working fluid outlet channel section 114′, the working fluid distribution chamber 116, the plurality of working fluid outlet openings 118a, and the plurality of working fluid inlet openings 118b. The working fluid distribution chamber 116 communicates with the working fluid inlet channel section 112′. The working fluid outlet openings 118a communicate with the working fluid distribution chamber 116. The working fluid inlet openings 118b communicate with the working fluid outlet channel section 114′. The working fluid inlet channel section 112′ is used to define a part of the working fluid inlet channel 112 (FIG. 3), and the working fluid outlet channel section 114′ is used to define a part of the working fluid outlet channel 114 (FIG. 3). Based on the design of the sub block 110′, in this embodiment, through modularization, the plurality of sub blocks 110′ is fabricated, and then the plurality of sub blocks 110′ is combined to form the block 110 with a preset size. In other words, the length of the working fluid inlet channel 112 and the working fluid outlet channel 114 of the block 110 are respectively defined by the working fluid inlet channel sections 112′ and the working fluid outlet channel sections 114′ of the sub blocks 110′.

Preferably, in order to more conveniently and firmly assemble the sub blocks 110′, in this embodiment, at least one male connector 119a is formed on one side of the sub block 110′ and at least one female connector 119b is formed on the other side of the sub block 110′. In this manner, the male connector 119a of the sub block 110′ is inserted to the female connector 119b of another sub block 110′, so as to quickly joint the two sub blocks 110′.

Preferably, the male connector 119a has a through hole, and the male connector 119a communicates with one of the working fluid inlet channel section 112′ and the working fluid outlet channel section 114′ on one side of the sub block 110′. In addition, the female connector 119b also communicates with one of the working fluid inlet channel section 112′ and the working fluid outlet channel section 114′ on the other side of the sub block 110. Therefore, during the assembly process, in this embodiment, the working fluid inlet channel section 112′ and the working fluid outlet channel section 114′ of one sub block 110′ may be quickly and accurately aligned with the working fluid inlet channel section 112′ and the working fluid outlet channel section 114′ of another sub block 110′ respectively, so as to define the working fluid inlet channel 112 through the working fluid inlet channel sections 112′, and define the working fluid outlet channel 114 through the working fluid outlet channel sections 114′.

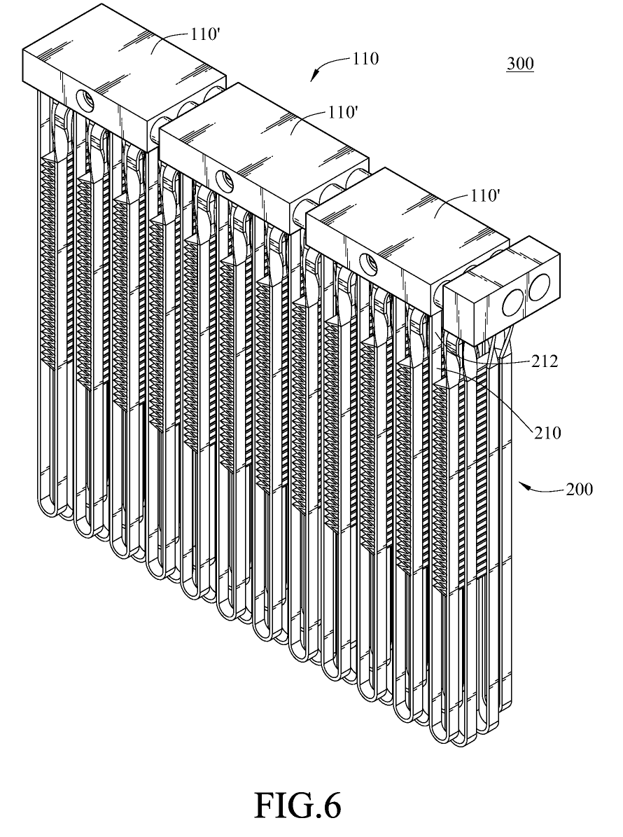

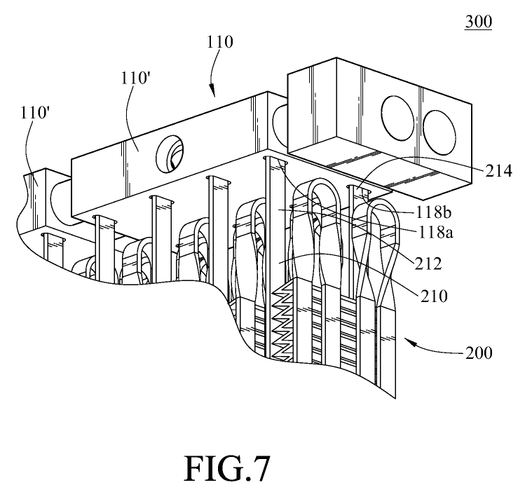

FIG. 6 is a schematic view of a heat transfer tube module 210 having the block 110 according to an embodiment of the present invention, and FIG. 7 is a schematic partial enlarged view of FIG. 6. Referring to FIGS. 3, 6, and 7, based on the structure of the block 110, the present invention further provides a micro-channel heat exchanger module 300, which includes a heat transfer tube module 200 and a block 110. The block 110 communicates with the heat transfer tube module 200, such that the working fluid from the compressor enters the heat transfer tube module 200 through the block 110, and the working fluid may perform the heat exchanger with the external air in heat sink fins of the heat transfer tube module 200, so as to dissipate the heat delivered by the working fluid. The working fluid may be the carbon dioxide refrigerant or other types of refrigerants. Then, the working fluid after the heat exchanger enters the element of a next channel from the heat transfer tube module 200 through the block 110. The combination of the heat transfer tube module 200 and the block 110 is described in detail as follows.

The heat transfer tube module 200 includes a plurality of heat transfer tube module 210, and each of the heat transfer tube module 210 has a first end 212 and a second end 214. The first end 212 communicates with the working fluid outlet openings 118a, and the second end 214 communicates with the working fluid inlet openings 118b. In this embodiment, an extending direction of the first end 212 is vertical to an extending direction of the working fluid inlet channel 112 (see FIG. 3). In addition, an extending direction of the second end 214 is vertical to an extending direction of the working fluid outlet channel 114 (see FIG. 3). In this manner, the working fluid may enter the first end 212 from the working fluid distribution chamber 116 (see FIG. 3), and then the working fluid dissipates the heat to the external environment in the heat transfer tube module 210. Then, the working fluid after heat dissipation enters the working fluid outlet channel 114 through the second end 214. In addition, in order to improve the heat dissipation performance of the heat transfer tube module 210, in other embodiments of the present invention, a plurality of heat sink fins may be disposed on the heat transfer tube module 210. As the technique of improving the heat conduction performance of the heat transfer tube module 210 is quite mature, the detailed description is not given here.

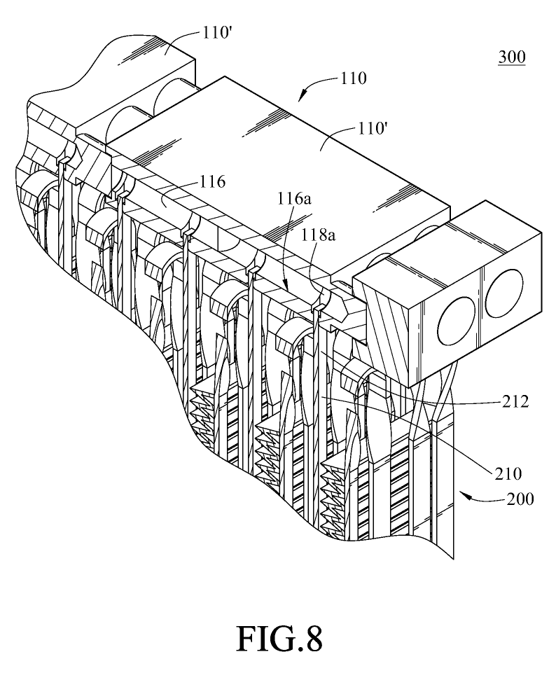

Accordingly, in addition to the design of the working fluid distribution chamber 116, in this embodiment, the relative position of the first end 212 of the heat transfer tube module 210 and the working fluid distribution chamber 116 (Referring to FIG. 3) may be adjusted to improve the smoothness of the flow of the working fluid. Referring to FIG. 8, a schematic sectional view relative to the first end 212 of FIG. 6 is shown. The working fluid distribution chamber 116 has a chamber bottom surface 116a. The first end 212 of the heat transfer tube module 210 is inserted to the block 110 through the working fluid outlet opening 118a. It should be noted that in order to make the working fluid smoothly flow from the working fluid distribution chamber 116 to the heat transfer tube bank 210, the first end 212 of the heat transfer tube module 210 is not raised to the working fluid distribution chamber 116 from the chamber bottom surface 116a, that is, a height of the end surface of the first end 212 may be lower than or equal to a height of the chamber bottom surface 116a. As compared with the prior art, the design effectively prevents the first end 212 of the heat transfer tube module 210 from obstructing the channel of the working fluid, such that the design improves the smoothness of the flow of the working fluid.

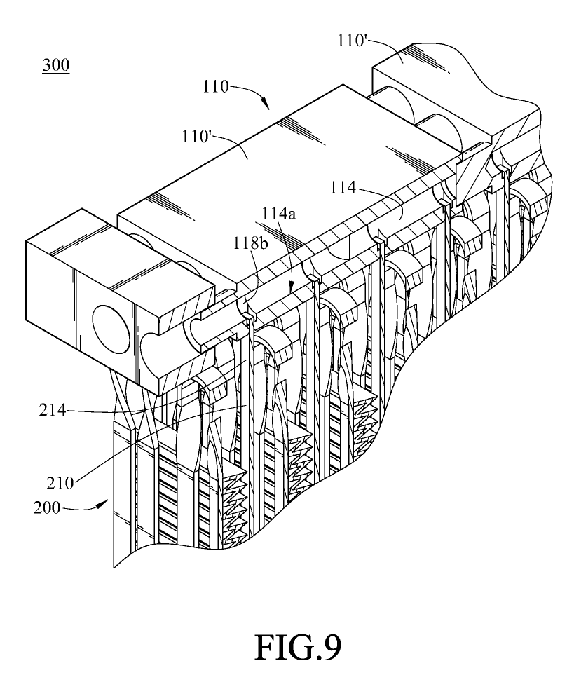

Referring to FIG. 9, a schematic sectional view relative to the second end 214 of FIG. 6 is shown. Similarly, the similar design of the relative position of the first end 212 and the working fluid distribution chamber 116 may be adopted between the second end 214 of the heat transfer tube module 210 and the working fluid outlet channel 114. In order to improve the smoothness of the working fluid flow, in this embodiment, the relative position of the second end 214 of the heat transfer tube module 210 and the working fluid outlet channel 114 may be adjusted. The working fluid outlet channel 114 has a channel bottom surface 114a. The second end 214 of the heat transfer tube module 210 is inserted to the block 110 through the working fluid inlet opening 118b. It should be noted that in order to make the working fluid smoothly flow from the heat transfer tube module 210 to the working fluid outlet channel 114, the second end 214 of the heat transfer tube module 210 is not raised to the working fluid outlet channel 114 from the through chamber bottom surface 116a, that is, a height of the end surface of the second end 214 is lower than or equal to a height of the channel bottom surface 114a.

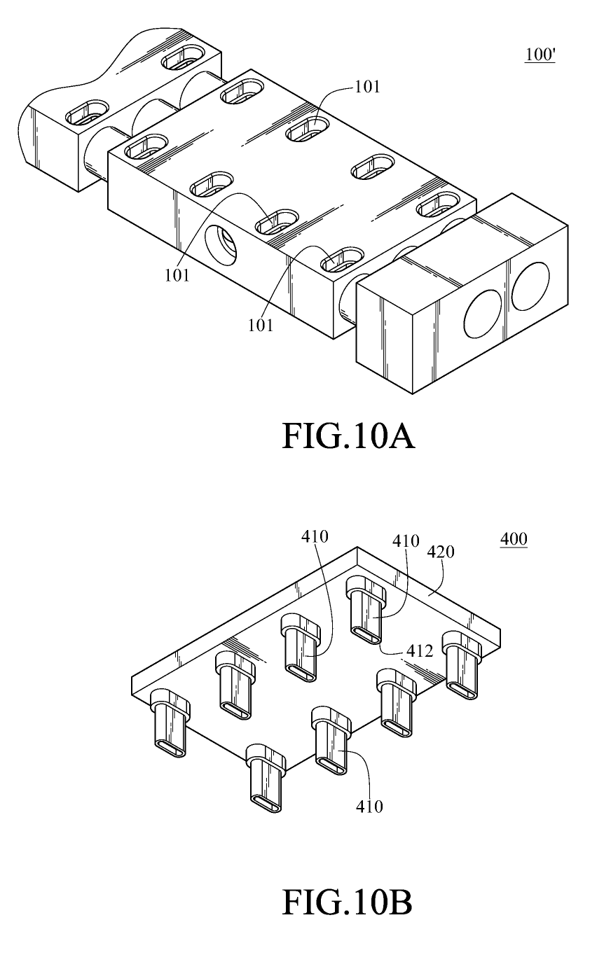

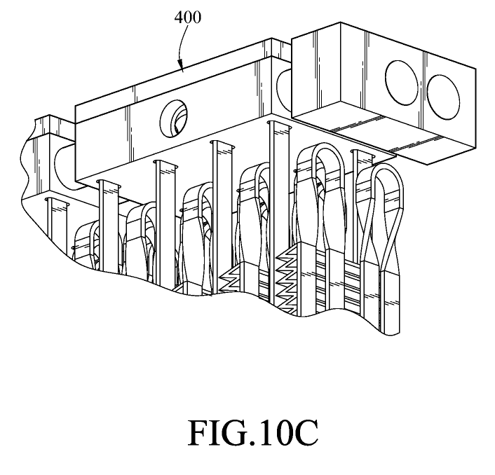

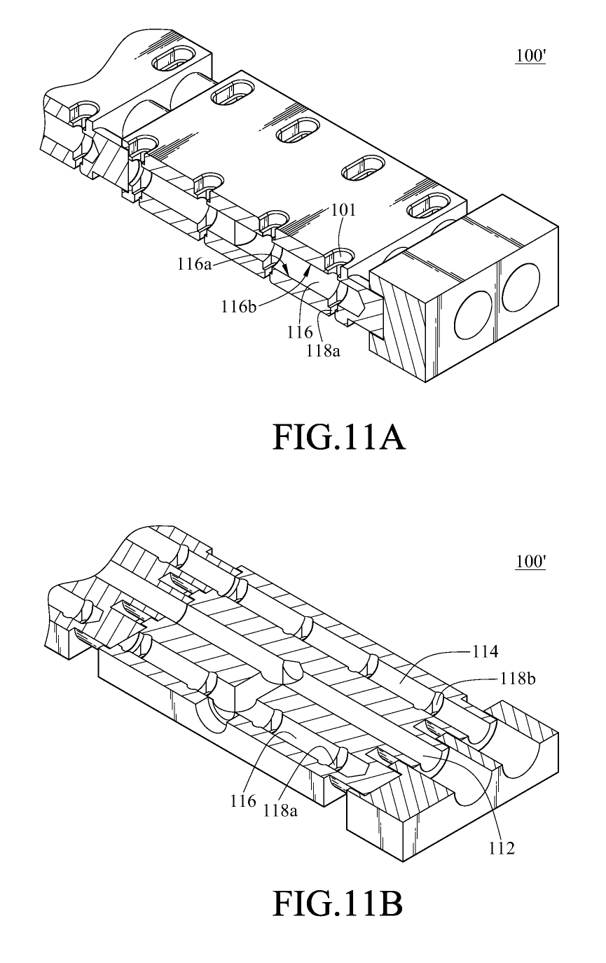

The method of fabricating the micro-channel heat exchanger module 300 is described in detail as follows. FIGS. 10A to 10C are schematic flow charts of fabricating the micro-channel heat exchanger module 300 according to an embodiment of the present invention. Referring to FIG. 10A, firstly an object to be processed 100′ is provided. Referring to FIGS. 11A and 11B, FIG. 11A is a schematic longitudinal sectional view of FIG. 10A, and FIG. 11B is a schematic cross-sectional view of FIG. 10A. The structure of the object to be processed 100′ is similar to that of the block 110. The object to be processed 100′ has a working fluid inlet channel 112, a working fluid outlet channel 114, a working fluid distribution chamber 116, and a plurality of working fluid openings. Being different from the block 110, the object to be processed 100′ further has a plurality of soldering openings 101. The working fluid distribution chamber 116 communicates with the working fluid inlet channel 112. The working fluid distribution chamber 116 has a chamber bottom surface 116a. The working fluid openings are located on the chamber bottom surface 116a. A part of the working fluid openings communicate with the working fluid distribution chamber 116, and the remaining working fluid openings communicate with the working fluid outlet channel 114. The soldering openings 101 communicate the working fluid distribution chamber 116 with the external environment, and the soldering openings 101 are located on a chamber top surface 116b of the working fluid distribution chamber 116 opposite to the chamber bottom surface 116a.

Referring to FIG. 10B, next, a plurality of stopping blocks 410 is provided, and a solder resist process (for example, a carbonizing process) is performed on surfaces of the stopping blocks 410. In this embodiment, the stopping blocks 410 are formed on a plate body plate body 420, so as to form a stopping block module 400. In this manner, during the fabricating flow, in this embodiment, the position of the plurality of stopping blocks 410 may be moved at the same time by operating the stopping block module 400.

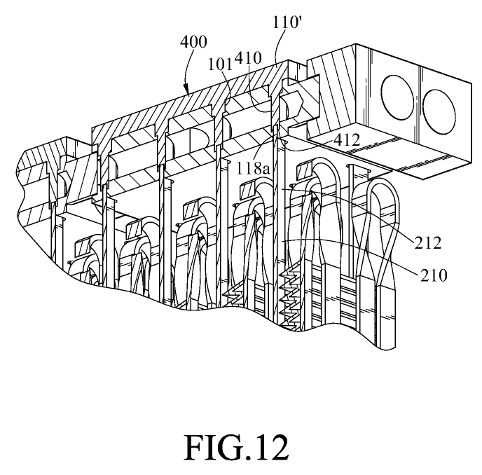

Referring to FIGS. 10C and 12, FIG. 12 is a schematic sectional view of FIG. 10C. Next, the stopping block module 400 is disposed on the block 110, such that each stopping block 410 is inserted to the block 110 through the soldering opening 101, and the end portion of each stopping block 410 is inserted to the corresponding working fluid outlet opening 118a. Next, a plurality of heat transfer tube module 210 is provided. The first end 212 of each heat transfer tube module 210 is inserted to the block 110 through the working fluid outlet opening 118a, and each first end 212 contacts with the corresponding stopping block 410. Preferably, the end surface of each stopping block 410 has a flange 412 corresponding to the first end 212 of the heat transfer tube module 210, and when the stopping block 410 contacts with the first end 212 of the heat transfer tube module 210, the flange 412 surrounds an outer surface of the first end 212.

Similarly, in this embodiment, each stopping block 410 is inserted to the block 110 through the soldering opening 101 by using the similar method, and the end portion of each stopping block 410 is inserted to the corresponding working fluid inlet opening 118b. Then, the second end 214 of each heat transfer tube module 210 is inserted to the block 110 through the working fluid inlet opening 118b, and each second end 214 contacts with the corresponding stopping block 410.

Next, for example, the heat transfer tube module 210 is soldered to the object to be processed 100′ by brazing. The solder resist process is performed on the surfaces of the stopping blocks 410, such that during brazing, the solder will not enter the contacting surfaces of the first ends 212 and the stopping blocks 410 under the effect of the capillary action. Then, the stopping block module 400 is moved, so as to remove the stopping blocks 410 from the block 110. Next, the soldering openings 101 are sealed, so as to form the micro-channel heat exchanger module 300 as shown in FIG. 6.

To sum up, the present invention has the working fluid distribution chamber connected between the working fluid inlet channel and the working fluid outlet opening, such that as compared with the prior art, the working fluid of the present invention flows to each heat transfer tube module 210 much smoother and more uniform. In addition, the end of the heat transfer tube module inserted to the working fluid outlet opening is not raised to the working fluid distribution chamber, and the other end of the heat transfer tube module inserted to the working fluid inlet opening is not raised to the working fluid outlet channel, such that as compared with the prior art, the design may further improve the smoothness of the flow of the working fluid. Further, the present invention adopts the design of the stopping block, such that by appropriately controlling a depth of the stopping block inserted to each working fluid opening, during the fabrication of the micro-channel heat exchanger module, in the present invention, each end portion of the heat transfer tube module may be inserted to the working fluid opening, and the relative position of each end portion of the heat transfer tube module and the block is quickly positioned.

What is claimed is:

1. A working fluid distributor, respectively connected to a compressor, an expansion device, and a heat transfer tube module, comprising:
a block, having a working fluid inlet channel, a working fluid outlet channel, a working fluid distribution chamber, a plurality of working fluid outlet openings, and a plurality of working fluid inlet openings, wherein the working fluid inlet channel is connected to one of a compressor and an expansion device, the working fluid distribution chamber communicates with the working fluid inlet channel, the working fluid outlet openings communicate the working fluid distribution chamber with the heat transfer tube module, the working fluid inlet openings communicate the working fluid outlet channel with the heat transfer tube module, and the working fluid outlet channel communicates with the other one of the compressor and the expansion device.

2. The working fluid distributor according to claim 1, wherein the block comprises a plurality of sub blocks, each sub block has a working fluid inlet channel section, a working fluid outlet channel section, the working fluid distribution chamber, the working fluid outlet openings, and the working fluid inlet openings, the working fluid distribution chamber communicates with the working fluid inlet channel section, the working fluid inlet openings communicate with the working fluid outlet channel section, the working fluid inlet channel section defines a part of the working fluid inlet channel, and the working fluid outlet channel section defines a part of the working fluid outlet channel.

3. The working fluid distributor according to claim 2, wherein the sub block further comprises a male connector and a female connector, and the male connector of the sub block is jointed with the female connector of another sub block.

4. The working fluid distributor according to claim 3, wherein the male connector communicates with one of the working fluid inlet channel section and the working fluid outlet channel section.

5. The working fluid distributor according to claim 3, wherein the female connector communicates with one of the working fluid inlet channel section and the working fluid outlet channel section.

6. The working fluid distributor according to claim 1, wherein the working fluid distributor is a distributor of carbon dioxide refrigerant.

7. A micro-channel heat exchanger module, respectively connected to a compressor and an expansion device, comprising:
a heat transfer tube module; and
a block, having a working fluid inlet channel, a working fluid outlet channel, a working fluid distribution chamber, a plurality of working fluid outlet openings, and a plurality of working fluid inlet openings, wherein the working fluid inlet channel is connected to one of a compressor and an expansion device, the working fluid distribution chamber communicates with the working fluid inlet channel, the working fluid outlet openings communicate the working fluid distribution chamber with the heat transfer tube module, the working fluid inlet openings communicate the working fluid outlet channel with the heat transfer tube module, and the working fluid outlet channel communicates with the other one of the compressor and the expansion device.

8. The micro-channel heat exchanger module according to claim 7, wherein the micro-channel heat exchanger module is a micro-channel heat exchanger module of carbon dioxide refrigerant.

9. The micro-channel heat exchanger module according to claim 8, wherein the heat transfer tube module comprises a plurality of heat transfer tube modules, each heat transfer tube module has a first end and a second end, the first end communicates with a corresponding working fluid outlet opening, and the second end communicates with a corresponding working fluid inlet opening.

10. The micro-channel heat exchanger module according to claim 9, wherein an extending direction of the first end is vertical to an extending direction of the working fluid inlet channel.

11. The micro-channel heat exchanger module according to claim 9, wherein an extending direction of the second end is vertical to an extending direction of the working fluid outlet channel.

12. The micro-channel heat exchanger module according to claim 9, wherein the working fluid distribution chamber has a chamber bottom surface, the working fluid outlet opening is located on the chamber bottom surface, the first end is inserted to the block from the working fluid outlet opening, and the first end is not raised to the working fluid distribution chamber from the chamber bottom surface.

13. The micro-channel heat exchanger module according to claim 12, wherein the working fluid outlet channel has a channel bottom surface, the working fluid outlet is located on the channel bottom surface, the second end is inserted to the block from the working fluid inlet opening, and the second end is not raised to the working fluid outlet channel from the channel bottom surface.

14. The micro-channel heat exchanger module according to claim 8, wherein the block comprises a plurality of sub blocks, each sub block has a working fluid inlet channel section, a working fluid outlet channel section, the working fluid distribution chamber, the working fluid outlet openings, and the working fluid inlet openings, the working fluid distribution chamber communicates with the working fluid inlet channel section, the working fluid inlet openings communicate with the working fluid outlet channel section, the working fluid inlet channel section defines a part of the working fluid inlet channel, and the working fluid outlet channel section defines a part of the working fluid outlet channel.

15. The micro-channel heat exchanger module according to claim 14, wherein the sub block further comprises a male connector and a female connector, and the male connector of the sub block is jointed with the female connector of another sub block.

16. The micro-channel heat exchanger module according to claim 15, wherein the male connector communicates with one of the working fluid inlet channel section and the working fluid outlet channel section.

17. The micro-channel heat exchanger module according to claim 15, wherein the female connector communicates with one of the working fluid inlet channel section and the working fluid outlet channel section.

18. A method of fabricating a micro-channel heat exchanger module, comprising:
providing an object to be processed having a working fluid inlet channel, a working fluid outlet channel, a working fluid distribution chamber, a plurality of working fluid openings, and a plurality of soldering openings, wherein the working fluid distribution chamber communicates with the working fluid inlet channel, the working fluid distribution chamber has a chamber bottom surface, the working fluid opening is located on the bottom surface, a part of the working fluid openings communicate with the working fluid distribution chamber, the remaining working fluid openings communicate with the working fluid outlet channel, the soldering openings communicate the working fluid distribution chamber with an external environment, and the soldering openings are located on a chamber top surface of the working fluid distribution chamber;
providing a plurality of heat transfer tube module and a plurality of stopping blocks, and performing a solder resist process on the stopping blocks;
communicating an end portion of the heat transfer tube module with the working fluid outlet channel, inserting the other end portion of the heat transfer tube module to the corresponding working fluid outlet opening, making the other end portion not raise to the working fluid distribution chamber from the chamber bottom surface, and inserting the stopping blocks to the working fluid distribution chamber through the soldering openings, such that a surface of the stopping blocks leans against an end surface of the end portion of the heat transfer tube module;
performing a soldering process, so as to fix the heat transfer tube module on the object to be processed;
removing the stopping blocks; and
sealing the soldering openings.

19. The method of fabricating a micro-channel heat exchanger module according to claim 18, wherein the soldering step is a brazing procedure.

20. The method of fabricating a micro-channel heat exchanger module according to claim 18, further comprising forming a flange with a profile corresponding to the end portion of the heat transfer tube module on the end surface of the stopping block, wherein when the stopping block contacts with the end portion of the heat transfer tube module, the flange surrounds an outer surface of the end portion.

21. The method of fabricating a micro-channel heat exchanger module according to claim 18, wherein the step of performing the solder resist process on the stopping blocks comprises performing a carbonizing process on the surfaces of the stopping blocks.
